(19) United States
(12) Patent Application Publication
(10) Pub. No.: US 2026/0285004 A1
(43) Pub. Date: Sep. 24, 2026

(54) COMPOSITE MATERIAL WITH STRETCHABLE INSULATION AND BREATHABLE LINER

(71) Applicant: The North Face Apparel Corp., Philadelphia, PA (US)

(72) Inventors: Stephen Lewandowski, Morrison, CO (US); Forrest Cannon, Wheat Ridge, CO (US); Kyle Watson, Northglenn, CO (US); Cory Olson, Morrison, CO (US)

(21) Appl. No.: 19/571,329

(22) Filed: Mar. 18, 2026

Related U.S. Application Data
(60) Provisional application No. 63/773,583, filed on Mar. 18, 2025.

(51) Int. Cl. B32B 5/26; B32B 3/26; B32B 5/02; D03D 15/217; D03D 15/283; D04B 1/16; D04B 1/24

(52) U.S. Cl. CPC B32B 5/265; B32B 3/266; B32B 5/022; B32B 5/024; B32B 5/026; D03D 15/217; D03D 15/283; D04B 1/16; D04B 1/24; B32B 2250/20; B32B 2262/0261; B32B 2262/0276; B32B 2262/0292; B32B 2262/062; B32B 2307/304; B32B 2307/51; B32B 2307/718; B32B 2307/724; B32B 2307/7375; B32B 2437/00; D10B 2201/02; D10B 2331/02; D10B 2331/04; D10B 2331/10; D10B 2401/061; D10B 2501/00

(57) ABSTRACT

The present disclosure provides a composite material comprising a shell fabric, an insulation layer, and a liner fabric. The shell fabric forms an exterior layer and may have stretch properties, a durable water repellent treatment, and a selected air permeability. The insulation layer includes a padding material and a nonwoven material, where the nonwoven material is adhered to the padding material and provides stretch and recovery properties. In some constructions, the nonwoven material is oriented toward the shell fabric. In alternative constructions, the nonwoven material is oriented toward the liner fabric. The liner fabric forms an innermost layer and may have stretch properties and air permeability selected for breathability and durability. The composite material may provide moisture-vapor transfer, low evaporative resistance, and favorable packability while maintaining insulation properties.

### CROSS-REFERENCE TO RELATED APPLICATION

This application is a Nonprovisional of and claims the benefit to Provisional Application No. 63/773,583, filed Mar. 18, 2025, which is hereby incorporated by reference in its entirety for any and all purposes.

### FIELD OF INVENTION

The present disclosure relates to composite materials for garments, and more particularly to a stretchable and breathable composite material with an insulation layer and a one or more of a shell fabric or a liner fabric.

### BACKGROUND

Composite materials for garments have been developed to provide insulation and moisture management for various activities. These materials typically consist of multiple layers, each serving a specific purpose in regulating body temperature and comfort. However, existing composite materials often struggle to balance thermal insulation with breathability, especially during high-intensity activities. Additionally, many current materials lack the ability to stretch and recover effectively, limiting their performance in dynamic movements. The durability of these materials, particularly in terms of fiber migration and shape retention after repeated use and washing, has also been a concern.

Improvements are needed.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

A composite garment or composite material is provided. The composite garment may include a shell fabric layer, an insulation layer, and a liner fabric layer. The shell fabric layer may be furthest from a body when the composite garment is worn. The insulation layer may be between the shell fabric layer and the liner fabric layer. The liner fabric layer may be closest to the body when the composite garment is worn.

The insulation layer may include a padding insulation, such as a synthetic padding insulation, and a stretchable nonwoven layer adhered to the padding insulation. The stretchable nonwoven layer may be disposed on a side of the padding insulation that faces the shell fabric layer. In other examples, the stretchable nonwoven layer may be disposed on a side of the padding insulation that faces the liner fabric layer.

The liner fabric layer may be woven, knit, or otherwise formed as a textile layer. The liner fabric layer may have stretch. Air permeability of the liner fabric layer may be measured in accordance with ASTM D737. The liner fabric layer may have an air permeability greater than 75 CFM, 200 CFM or greater, from 25 CFM to 126 CFM, or another value or intervening range. In some constructions, the liner fabric layer may include pores or apertures up to about 1 millimeter in maximum dimension.

The insulation layer may have stretch in a machine direction and a cross-machine direction. Stretch may be measured in accordance with ASTM D2594, ASTM D6614, or another suitable method. The insulation layer may have stretch from 5% to 40%, from 10% to 40%, from 15% to 40%, or from 20% to 40% in one or both of the machine direction and the cross-machine direction. The stretchable nonwoven layer may improve recovery of the insulation layer after stretching, may reduce fiber migration, and may improve comfort relative to adhesive-containing insulation constructions.

The insulation layer may include a padding insulation, such as a synthetic padding insulation, and a stretchable nonwoven layer adhered to the padding insulation. The stretchable nonwoven layer may be disposed on a side of the padding insulation that faces the shell fabric layer. In some examples, positioning the stretchable nonwoven layer on the shell-facing side may improve manufacturability, may reduce friction during sewing, and may provide a desirable combination of stretch, recovery, and durability. In other examples, the stretchable nonwoven layer may be disposed on a side of the padding insulation that faces the liner fabric layer.

The insulation construction, alone or in combination with the shell fabric layer and the liner fabric layer, may exhibit low evaporative resistance. Evaporative resistance may be characterized as intrinsic isothermal evaporative resistance Ref in accordance with ASTM F1869 Part B. Ref may be from 0.01 to 0.02 [(kPa)(m2)/W], or another value or intervening range.

The composite garment may further exhibit improved packability. Packability may be measured by placing a garment or material sample in a cylindrical fixture, applying a defined force load, allowing the load to rest for a dwell time, repeating the measurement for three repetitions, and reporting an average compressed final volume. In one suitable procedure for garments, a cylindrical fixture with an inner diameter of about 7.5 inches and a height of about 24 inches may be used with a total weight of about 43.1 pounds and a dwell time of about 5 minutes. The measured packability may distinguish the disclosed insulation construction from other sheet insulations that achieve low evaporative resistance through different constructions.

The foregoing general description of the illustrative embodiments and the following detailed description thereof are merely exemplary aspects of the teachings of this disclosure and are not restrictive.

### BRIEF DESCRIPTION OF FIGURES

The accompanying drawings, which are incorporated in and constitute a part of this specification, show embodiments and together with the description, serve to explain the principles of the methods and systems: Some features are shown by way of example, and not by limitation, in the accompanying drawings. In the drawings, like numerals reference similar elements.

FIG. 1 illustrates a layered structure of a composite garment, according to aspects of the present disclosure.

FIG. 2 shows a flow diagram of example methods according to the present disclosure.

The accompanying drawings show examples of the disclosure. It is to be understood that the examples shown in the drawings and/or discussed herein are non-exclusive and that there are other examples of how the disclosure may be practiced.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to a composite garment designed for improved thermal insulation, moisture management, stretch and recovery, and packability during physical activities. This composite garment may provide enhanced comfort and performance for wearers engaged in various levels of exertion. The layered structure may provide effective heat retention while facilitating moisture-vapor transfer away from a wearer.

In some cases, the composite garment may offer stretch capabilities, enabling a close fit and unrestricted movement during wear. The combination of materials used in the composite garment may provide improved recovery after stretching, potentially maintaining the garment's shape and insulation properties over time.

The composite garment may incorporate features that address common challenges associated with insulated garments, such as fiber migration and breathability. These features may contribute to the durability and functionality of the garment, potentially extending its useful life and maintaining performance through multiple wear and wash cycles.

The design of the composite garment may allow for adaptability to different environmental conditions and activity levels. This adaptability may be achieved through the careful selection and arrangement of materials in each layer of the garment, potentially offering a balance between warmth and breathability.

In some implementations, the composite garment may be suitable for use in a wide range of applications, from casual wear to specialized athletic or outdoor activities. The versatility of the garment may stem from its ability to provide insulation while managing moisture and allowing for freedom of movement.

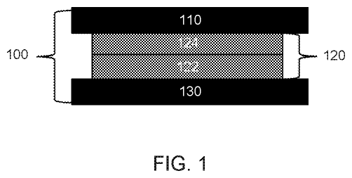

The composite garment 100 may comprise a layered structure as illustrated in FIG. 1. In some cases, the composite garment 100 may include three main layers: a shell fabric 110, an insulation layer 120, and a liner fabric 130. These layers may be arranged in a sequential configuration to provide specific functionalities and characteristics to the composite garment 100.

The shell fabric 110 may form the exterior layer of the composite garment 100. This layer may be positioned furthest from the body when the composite garment 100 is worn. In some cases, the shell fabric 110 may serve as a protective barrier against external elements.

The insulation layer 120 may be positioned between the shell fabric 110 and the liner fabric 130. This layer may provide insulation properties to the composite garment 100. In some implementations, the insulation layer 120 may comprise multiple components, which may be described in more detail in subsequent sections. As an illustrative example, the insulation layer may include a padding material and a nonwoven material arranged on either side of the padding material, with the nonwoven material positioned adjacent the shell fabric in some constructions and adjacent the liner fabric in other constructions. As an illustration, the nonwoven material may be disposed on only one side of the padding material.

The liner fabric 130 may form the innermost layer of the composite garment 100. This layer may be positioned closest to the body when the composite garment 100 is worn. In some cases, the liner fabric 130 may contribute to moisture management and comfort for the wearer. The liner fabric may itself be configured for a stretch property. Other materials herein may be configured for desired stretch property.

The arrangement of these layers in the composite garment 100 may allow for a combination of properties, potentially including thermal insulation, moisture management, and comfort. The specific characteristics and functions of each layer may be further detailed in the following sections.

The shell fabric 110 of the composite garment 100 may serve as the outermost layer, providing protection and contributing to the overall performance of the garment. In some cases, the shell fabric 110 may possess stretch capabilities, allowing for flexibility and ease of movement when the composite garment 100 is worn.

The shell fabric 110 may be constructed using various fabric types. In some implementations, the shell fabric 110 may be a knit fabric. In other implementations, the shell fabric 110 may be a woven fabric. The choice between knit and woven construction may depend on the specific requirements of the intended use of the composite garment 100.

In some cases, the shell fabric 110 may have a durable water repellent (DWR) treatment applied to its surface. This DWR application may enhance the water-resistant properties of the shell fabric 110, potentially improving the composite garment's 100 performance in wet conditions.

The air permeability of the shell fabric 110 may be characterized by its cubic feet per minute (CFM) rating. In some implementations, the shell fabric 110 may have a CFM rating ranging from 10 to 75 CFM. This range of air permeability may contribute to the breathability of the composite garment 100 while potentially maintaining a balance with other performance characteristics. The shell fabric 110 may have an air permeability from 10 CFM to 160 CFM. The shell fabric 110 may have an air permeability from 25 CFM to 126 CFM in constructions selected to balance breathability and durability. The shell fabric 110 may have an air permeability from 10 CFM to 75 CFM in other constructions. Shell fabrics above about 126 CFM may be usable in some constructions, but may present an increased abrasion or wash-durability risk in certain implementations.

The structure of the shell fabric 110 may be selected to provide a desired balance of porosity, breathability, and durability. In some constructions, pores or apertures in the shell fabric 110 may be less than about 1 millimeter in maximum dimension. In other constructions, pores or apertures may be up to about 1 millimeter in maximum dimension. The selected porosity may contribute to abrasion resistance, wash durability, and moisture management.

The characteristics of the shell fabric 110, including its potential for stretch, fabric type, DWR application, CFM range, and selected porosity, may work in conjunction with the other layers of the composite garment 100 to provide a balance of protection, comfort, and performance.

The insulation layer 120 of the composite garment 100 may be positioned between the shell fabric 110 and the liner fabric 130. In some cases, the insulation layer 120 may comprise a padding material 122 and a nonwoven material 124, which may work together to provide insulation and other functional properties to the composite garment 100.

The padding material 122 may be a synthetic (e.g., polyester) padding insulation. In some implementations, the padding material 122 may have a weight ranging from 20 to 80 grams per square meter (gsm). This range of weights may allow for varying levels of insulation depending on the specific requirements of the composite garment 100. The padding material 122 may include a synthetic padding insulation, such as polyester padding insulation, and may have a basis weight from 20 gsm to 80 gsm, from 20 gsm to 90 gsm, from 20 gsm to 100 gsm, or another value or intervening range.

A nonwoven material 124 may be adhered to the padding material 122. In some cases, the nonwoven material 124 may be an elastomeric or stretch nonwoven layer. The nonwoven material 124 may be adhered to the padding material 122 on the side of the padding material 122 that faces the shell fabric 110. Positioning the nonwoven material 124 adjacent the shell fabric 110 may improve manufacturability by reducing friction against sewing equipment when the shell fabric 110 is sewn to the insulation layer 120. The nonwoven material 124 may also improve stretch recovery and may reduce fiber migration. In alternative constructions, the nonwoven material 124 may be adhered to the padding material 122 on a side that faces the liner fabric 130. Accordingly, FIG. 1 is schematic, and the nonwoven material 124 may be arranged on either side of the padding material 122.

The arrangement of the insulation layer 120 within the composite garment 100 may be such that the nonwoven material 124 is oriented next to the shell fabric 110. This orientation may contribute to manufacturability and may support a favorable combination of stretch, recovery, and durability. In alternative constructions, the nonwoven material 124 may be oriented next to the liner fabric 130.

In some implementations, the insulation layer 120 may possess stretch capabilities. The insulation layer 120 may have the ability to stretch between 20% and 40% in both the machine direction and the cross-machine direction. This stretch capability may contribute to the overall flexibility and comfort of the composite garment 100.

The nonwoven material 124 may play a role in the recovery properties of the insulation layer 120. In some cases, the nonwoven material 124 may enable the insulation layer 120 to recover effectively after being stretched. This recovery capability may help the composite garment 100 maintain its shape and insulation properties over time and through multiple uses.

The insulation layer 120, alone or as part of a package including the shell fabric 110 and the liner fabric 130, may have a low evaporative resistance. This characteristic may contribute to moisture management properties of the composite garment 100, potentially allowing effective transfer of moisture vapor away from the body during wear. In some constructions, evaporative resistance may be characterized as intrinsic isothermal evaporative resistance Ref.

The combination of the padding material 122 and the nonwoven material 124 in the insulation layer 120, along with their specific properties and arrangement, may contribute to the overall performance of the composite garment 100. These features may work in conjunction with the shell fabric 110 and the liner fabric 130 to provide a balance of insulation, moisture management, and comfort in the composite garment 100.

The insulation layer 120 may have stretch in both a machine direction and a cross-machine direction. The insulation layer 120 may have stretch from 5% to 40%, from 10% to 40%, from 15% to 40%, or from 20% to 40% in one or both directions. Stretch may be measured under ASTM D2594, ASTM D6614, or another suitable method.

The stretchable nonwoven material 124 may improve recovery after stretching relative to insulation constructions that rely on adhesive to provide stretch and recovery. The stretchable nonwoven material 124 may also reduce fiber migration and may improve softness and comfort by reducing or avoiding adhesive content.

Evaporative resistance may be measured for the insulation layer 120 alone or for a package including the shell fabric 110, insulation layer 120, and liner fabric 130. In some constructions, intrinsic isothermal evaporative resistance Ref, measured in accordance with ASTM F1869 Part B, may be from 0.01 to 0.02 [(kPa)(m2)/W], from 0.01 to 0.018 [(kPa)(m2)/W], from 0.01 to 0.017 [(kPa)(m2)/W], from 0.01 to 0.016 [(kPa)(m2)/W], from 0.01 to 0.015 [(kPa)(m2)/W], from 0.01 to 0.014 [(kPa)(m2)/W], from 0.01 to 0.013 [(kPa)(m2)/W], or intervening endpoints. A low Ref value may be achieved while maintaining stretch, recovery, durability, and packability.

The liner fabric 130 of the composite garment 100 may form the layer closest to the body when the garment is worn. In some cases, the liner fabric 130 may possess stretch capabilities, potentially contributing to the overall flexibility and comfort of the composite garment 100.

The liner fabric 130 may be constructed using various fabric types. In some implementations, the liner fabric 130 may be a knit fabric. In other implementations, the liner fabric 130 may be a woven fabric. The choice between knit and woven construction may depend on the specific requirements of the intended use of the composite garment 100. The structure of the inner fabric 130 may be designed to allow for high porosity. In some implementations, the inner fabric 130 may have holes or openings up to 1 millimeter in diameter. This high porosity may facilitate effective evaporative heat transfer from the body to the microclimate of the composite garment 100.

The air permeability of the liner fabric 130 may be characterized by its cubic feet per minute (CFM) rating. In some constructions, the liner fabric 130 may have an air permeability greater than 75 CFM. In some constructions selected to balance breathability and durability, the liner fabric 130 may have an air permeability from 25 CFM to 126 CFM. In other constructions, the liner fabric 130 may have an air permeability of 200 CFM or greater. Air permeability may be measured in accordance with ASTM D737.

The composite garment 100 may provide thermal insulation, moisture management, and comfort through the interaction of the shell fabric 110, the insulation layer 120, and the liner fabric 130. These layers may work together to create a synergistic effect, potentially enhancing the overall performance of the composite garment 100.

In some cases, the shell fabric 110 may serve as a protective barrier while allowing controlled air permeability. The air permeability of the shell fabric 110 may be selected from any of the ranges described herein, including from 10 CFM to 160 CFM, from 25 CFM to 126 CFM, or from 10 CFM to 75 CFM, depending on the desired balance of breathability, durability, and protection.

The insulation layer 120, comprising the padding material 122 and the nonwoven material 124, may provide insulation properties to the composite garment 100. The padding material 122 may contribute to thermal insulation, while the nonwoven material 124 may enhance stretch recovery and may reduce fiber migration. In some constructions, the nonwoven material 124 may be arranged next to the shell fabric 110. In alternative constructions, the nonwoven material 124 may be arranged next to the liner fabric 130.

The liner fabric 130 may facilitate moisture-vapor transfer from the body to the microclimate of the composite garment 100. This property may work in tandem with the low evaporative resistance of the insulation layer 120 or the garment package to enhance moisture management.

The liner fabric 130 may form the innermost layer of the composite garment 100 and may be closest to the body when worn. The liner fabric 130 may be woven, knit, or otherwise formed and may include stretch. Air permeability of the liner fabric 130 may be measured in accordance with ASTM D737.

The liner fabric 130 may have an air permeability greater than 75 CFM. The liner fabric 130 may have an air permeability from 25 CFM to 126 CFM in constructions selected for durability through abrasion and wash cycles. The liner fabric 130 may have an air permeability of 200 CFM or greater in other constructions. The liner fabric 130 may include pores or apertures up to about 1 millimeter in maximum dimension.

The shell fabric 110, insulation layer 120, and liner fabric 130 may cooperate to transfer moisture vapor away from the body while maintaining thermal insulation. The disclosed arrangement may provide improved comfort over a wide range of activity levels.

Packability may be evaluated with an in-house method that is a scaled version of ASTM F1853. A garment sample may be randomly placed in a cylindrical acrylic tube having an inner diameter of about 7.5 inches and a height of about 24 inches. A weight apparatus providing a total load of about 43.1 pounds may be lowered onto the sample and allowed to rest for about 5 minutes. Height may then be measured, the sample may be allowed to re-loft, the procedure may be repeated for a total of three repetitions, and an average compressed final volume may be reported in cubic inches and/or liters.

A smaller fixture may be used for pillow samples or material yardage. For example, a cylindrical fixture having an inner diameter of about 5 inches and a height of about 12 inches may be used with a total load of about 21.5 pounds.

The disclosed insulation construction may provide a favorable combination of low Ref and low packability volume while maintaining stretch, recovery, comfort, and durability. Other constructions may achieve low evaporative resistance through different shell, liner, or insulation changes, but may sacrifice one or more of stretch, recovery, porosity, air permeability, comfort, or packability.

The disclosure accordingly encompasses composite materials, garments, and manufacturing methods in which the relative selection of shell permeability, liner permeability, insulation basis weight, stretch, nonwoven orientation, evaporative resistance, and packability are chosen to obtain a desired performance package.

The stretch capabilities of each layer may contribute to the overall flexibility and comfort of the composite garment 100. In some implementations, the ability of the layers to stretch and recover may allow the composite garment 100 to maintain its shape and insulation properties over time.

The arrangement of these layers, as illustrated in FIG. 1, may create a system where moisture vapor can be effectively transferred away from the body while maintaining thermal insulation. The shell fabric 110 may provide some protection against external elements, the insulation layer 120 may offer insulation and recovery properties, and the liner fabric 130 may facilitate moisture transfer.

In some cases, the combination of these layers may allow the composite garment 100 to adapt to different activity levels. During periods of high exertion, the moisture management properties may help regulate body temperature. During periods of low activity, the insulation properties may help retain warmth.

The synergistic effects of the layer arrangement and properties may potentially result in a composite garment 100 that provides a balance of thermal insulation, moisture management, and comfort across various conditions and activity levels.

Examples in Tables 1-2 show composite material in stacked configuration with shell fabric, insulation layer, and liner fabric arranged with insulation layer disposed between the shell and the liner. In the inventive example, the insulation layer was expressly tested with a nonwoven layer adhered to the insulative padding, as described herein. The control and Inventive Examples are shown with select shell and liner fabric with an associated CFM measurement. Other face and liner fabrics were tested and may be used. Various constructions and fabric weights may be selected and CFM of 25-126 showed favorable results, though broader ranges of 25-518 CFM may be used, as illustrated in Table 2. As shown in Table 3, other weight insulation may be used with the non-woven layer to improve Ref and/or packability.

TABLE 1

| | | | | | | Isothermal | |
|---|---|---|---|---|---|---|---|
| | | | | | | Evaporative | |
| | Insulation | | | | | Resistance | |
| Composite | Weight | | Shell | | Liner | (R_{ef}) (ASTM | |
| Material | (GSM) | Shell Fabric | CFM | Liner Fabric | CFM | F1869 Part B) | Packability |
| Control | 60 | 89% Nylon, | 31.6- | 89% Nylon, | 31.6- | 0.01820 | Control |
| (M34B) | | 11% Elastane | 38.1 | 11% Elastane | 38.1 | | |
| Inventive | 60 | 89% Nylon, | 31.6- | 89% Nylon, | 31.6- | 0.01297 | 59.5% more |
| Example | | 11% Elastane | 38.1 | 11% Elastane | 38.1 | | compressible |
| (MWE6) | | | | | | | |

TABLE 2

| Face/Liner | | Weight | | Air Permeability |
|---|---|---|---|---|
| Web Code | Construction Type | (gsm) | Fiber Content | (cfm) |
| LWFF | Stretch Weave Dobby | 71 | 89% Recycled Nylon/11% | 25.7 |
| | | | Elastane | |
| MUIO | Plain Weave | 87 | 75% Recycled Polyester/ | 28.7 |
| | | | 25% Polyester | |
| M017 | Plain Weave | 65 | 85% Recycled Polyester/ | 45.2 |
| | | | 15% Elastane | |
| N1FD | Dissolvable Weave | 91 | 86% Recycled Polyester/ | 93.3 |
| | | | 14% Recycled Elastane | |
| LWQ1 | Single Jersey Knit | 160 | 70% Cotton/30% Polyester | 124 |
| LZGD | Twill Weave | 130 | 60% Cotton/40% Recycled | 126 |
| | | | Polyester | |
| MRZV | Double Raschel Warp Knit | 65 | 100% Recycled Polyester | 402 |
| N12V | Pique Single Knit | 105 | 100% Recycled Polyester | 405 |
| MNZK | Pique Single Knit | 97 | 100% Recycled Polyester | 518 |

TABLE 3

| | | | | | | Isothermal | |
|---|---|---|---|---|---|---|---|
| | | | | | | Evaporative | |
| | Insulation | | | | | Resistance | |
| Composite | Weight | | Shell | | Liner | (R_{ef}) (ASTM | |
| Material | (GSM) | Shell Fabric | CFM | Liner Fabric | CFM | F1869 Part B) | Packability |
| Control | 80 | 89% Nylon, | 31.6- | 89% Nylon, | 31.6- | 0.02641 | NA |
| | | 11% Elastane | 38.1 | 11% Elastane | 38.1 | | |
| Inventive | 80 | 89% Nylon, | 31.6- | 89% Nylon, | 31.6- | 0.02274 | NA |
| Example | | 11% Elastane | 38.1 | 11% Elastane | 38.1 | | |

TABLE 4

| | Insulation | | | | | |
|---|---|---|---|---|---|---|
| Composite | Weight | | Shell | | Liner | Packability |
| Material | (GSM) | Shell Fabric | CFM | Liner Fabric | CFM | (In-house test) |
| Comparative 1 | 60 | NA | | NA | | 35.3% More |
| | | | | | | Compressible |
| Comparative 2 | 60 | NA | | NA | | 35.3% more |
| | | | | | | Compressible |
| Control | 60 | 89% Nylon, | 31.6- | 89% Nylon, | 31.6- | Control |
| | | 11% Elastane | 38.1 | 11% Elastane | 38.1 | |
| Inventive | 60 | 89% Nylon, | 31.6- | 89% Nylon, | 31.6- | 59.5% more |
| Example | | 11% Elastane | 38.1 | 11% Elastane | 38.1 | compressible |

As shown in Tables 1 and 3-4, the control was substantially similar to the inventive example, with the exception that a nonwoven layer was disposed on the padding material to form the insulation layer of the inventive example, and the control did not have a non-woven layer.

The composite material (garment) of the present disclosure may comprise a shell fabric having 25-126 CFM and can optionally be highly porous (up to 1 mm holes). The lining fabric may exhibit 25-126 CFM (ASTM D737). The nonwoven layer adhered to the insulation padding may be disposed adjacent only the shell fabric (and not on both sides of the padding insulation). The insulation stack of padding and nonwoven may have between 20% and 40% stretch (ASTM D2594) and may have weight of between 20 gsm and 80 gsm. The ranges provided support the improvement of Ref and packability over a comparative material stack consisting essentially of the same layers and materials as the inventive stack with the exception that the comparative material stack does not have the nonwoven layer on the insulation padding.

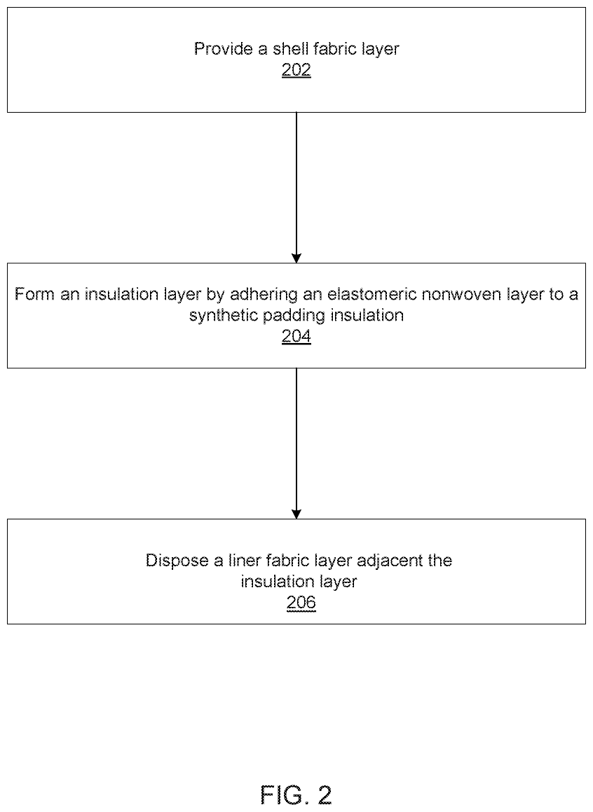

FIG. 2 shows a flow diagram of methods according to the present disclosure. A shell fabric layer may be provided (block 202). The shell fabric layer may have a CFM (cubic feet per minute) rating between 10 CFM and 160 CFM in accordance with ASTM D737. The shell fabric layer may have a CFM rating between 25 CFM and 126 CFM in accordance with ASTM D737. The shell fabric layer may have a CFM rating between 10 CFM and 75 CFM in accordance with ASTM D737.

An insulation layer may be formed by adhering an elastomeric nonwoven layer to a synthetic padding insulation (block 204). The synthetic padding insulation may have a weight ranging from 20 to 80 grams per square meter (gsm). The insulation layer may have stretch between 20% and 40% in both a machine direction and a cross-machine direction in accordance with ASTM D6614 or ASTM D2594. The insulation layer alone or a package including the shell fabric layer, the insulation layer, and the liner fabric layer may have an intrinsic isothermal evaporative resistance Ref from 0.01 to 0.02 [(kPa)(m2)/W], from 0.01 to 0.018 [(kPa)(m2)/W], from 0.01 to 0.017 [(kPa)(m2)/W], from 0.01 to 0.016 [(kPa)(m2)/W], from 0.01 to 0.015 [(kPa)(m2)/W], from 0.01 to 0.014 [(kPa)(m2)/W], from 0.01 to 0.013 [(kPa)(m2)/W], or intervening endpoints, measured in accordance with ASTM F1869 Part B. Packability of the composite garment may be measured by an in-house technique described herein above, but placing the composite garment in a cylindrical fixture and applying a force load to compress the composite garment. The force load may be applied for a dwell time of about five minutes. The packability may be determined by repeating the measurement three times and reporting an average compressed final volume.

A liner fabric layer may be disposed adjacent or attached to the insulation layer (block 206). The liner fabric layer may be attached to the insulation layer such that the elastomeric nonwoven layer is oriented toward the shell fabric layer. The liner fabric layer may be attached to the insulation layer such that the elastomeric nonwoven layer is oriented toward the liner fabric layer. The liner fabric layer may have an air permeability greater than 75 CFM. The liner fabric layer may have an air permeability from 25 CFM to 126 CFM. The liner fabric layer may have an air permeability of 200 CFM or greater. The liner fabric layer may have holes up to 1 millimeter in diameter. The liner fabric layer may allow for evaporative heat transfer from a body to a microclimate of the composite garment.

A number of implementations have been described. Nevertheless, it will be understood that various modifications may be made without departing from the spirit and scope of the disclosure. Accordingly, other implementations are within the scope of the following claims.

### EXAMPLE CLAUSES

Example Clause 1: A composite garment, comprising: a shell fabric layer; an insulation layer adjacent to the shell fabric layer, the insulation layer comprising a synthetic padding insulation and an elastomeric nonwoven layer adhered to the synthetic padding insulation; and a liner fabric layer adjacent to the insulation layer, wherein the elastomeric nonwoven layer is oriented toward the shell fabric layer.

Example Clause 2: The composite garment of Example Clause 1, wherein the shell fabric layer has a CFM (cubic feet per minute) rating between 10 CFM and 160 CFM in accordance with ASTM D737.

Example Clause 3: The composite garment of Example Clause 1 or Example Clause 2, wherein the shell fabric layer has a CFM (cubic feet per minute) rating between 25 CFM and 126 CFM in accordance with ASTM D737.

Example Clause 4: The composite garment of any one of Example Clauses 1-3, wherein the shell fabric layer has a CFM (cubic feet per minute) rating between 10 CFM and 75 CFM in accordance with ASTM D737.

Example Clause 5: The composite garment of any one of Example Clauses 1-4, wherein the synthetic padding insulation has a weight ranging from 20 to 80 grams per square meter (gsm).

Example Clause 6: The composite garment of any one of Example Clauses 1-5, wherein the insulation layer has stretch between 20% and 40% in both a machine direction and a cross-machine direction in accordance with ASTM D6614 or ASTM D2594.

Example Clause 7: The composite garment of any one of Example Clauses 1-6, wherein the liner fabric layer has an air permeability greater than 75 CFM.

Example Clause 8: The composite garment of any one of Example Clauses 1-7, wherein the liner fabric layer has holes up to 1 millimeter in diameter.

Example Clause 9: The composite garment of any one of Example Clauses 1-8, wherein the liner fabric layer allows for evaporative heat transfer from a body to a microclimate of the composite garment.

Example Clause 10: The composite garment of any one of Example Clauses 1-9, wherein the liner fabric layer has an air permeability from 25 CFM to 126 CFM.

Example Clause 11: The composite garment of any one of Example Clauses 1-10, wherein the liner fabric layer has an air permeability of 200 CFM or greater.

Example Clause 12: The composite garment of any one of Example Clauses 1-11, wherein the insulation layer alone or a package including the shell fabric layer, the insulation layer, and the liner fabric layer has an intrinsic isothermal evaporative resistance Ref from 0.01 to 0.02 [(kPa)(m2)/W], measured in accordance with ASTM F1869 Part B.

Example Clause 13: The composite garment of any one of Example Clauses 1-12, wherein packability of the composite garment is measured by placing the composite garment in a cylindrical fixture and applying a force load to compress the composite garment.

Example Clause 14: The composite garment of any one of Example Clauses 1-13, wherein the force load is applied for a dwell time of about five minutes.

Example Clause 15: The composite garment of any one of Example Clauses 1-14, wherein the packability is determined by repeating the measurement three times and reporting an average compressed final volume.

Example Clause 16: A method of manufacturing a composite garment, comprising: providing a shell fabric layer; forming an insulation layer by adhering an elastomeric nonwoven layer to a synthetic padding insulation; and attaching a liner fabric layer to the insulation layer such that the elastomeric nonwoven layer is oriented toward the shell fabric layer.

Example Clause 17: The method of Example Clause 16, wherein the shell fabric layer has a CFM (cubic feet per minute) rating between 10 CFM and 160 CFM in accordance with ASTM D737.

Example Clause 18: The method of Example Clause 16 or Example Clause 17, wherein the shell fabric layer has a CFM (cubic feet per minute) rating between 25 CFM and 126 CFM in accordance with ASTM D737.

Example Clause 19: The method of any one of Example Clauses 16-18, wherein the shell fabric layer has a CFM (cubic feet per minute) rating between 10 CFM and 75 CFM in accordance with ASTM D737.

Example Clause 20: The method of any one of Example Clauses 16-19, wherein the synthetic padding insulation has a weight ranging from 20 to 80 grams per square meter (gsm).

Example Clause 21: The method of any one of Example Clauses 16-20, wherein the insulation layer has stretch between 20% and 40% in both a machine direction and a cross-machine direction in accordance with ASTM D6614 or ASTM D2594.

Example Clause 22: The method of any one of Example Clauses 16-21, wherein the liner fabric layer has an air permeability greater than 75 CFM.

Example Clause 23: The method of any one of Example Clauses 16-22, wherein the liner fabric layer has holes up to 1 millimeter in diameter.

Example Clause 24: The method of any one of Example Clauses 16-23, wherein the liner fabric layer allows for evaporative heat transfer from a body to a microclimate of the composite garment.

Example Clause 25: The method of any one of Example Clauses 16-24, wherein the liner fabric layer has an air permeability from 25 CFM to 126 CFM.

Example Clause 26: The method of any one of Example Clauses 16-25, wherein the liner fabric layer has an air permeability of 200 CFM or greater.

Example Clause 27: The method of any one of Example Clauses 16-26, wherein the insulation layer alone or a package including the shell fabric layer, the insulation layer, and the liner fabric layer has an intrinsic isothermal evaporative resistance Ref from 0.01 to 0.02 [(kPa)(m2)/W], measured in accordance with ASTM F1869 Part B.

Example Clause 28: The method of any one of Example Clauses 16-27, wherein packability of the composite garment is measured by placing the composite garment in a cylindrical fixture and applying a force load to compress the composite garment.

Example Clause 29: The method of any one of Example Clauses 16-28, wherein the force load is applied for a dwell time of about five minutes.

Example Clause 30: The method of any one of Example Clauses 16-29, wherein the packability is determined by repeating the measurement three times and reporting an average compressed final volume.

Example Clause 31: A composite garment, comprising: a shell fabric layer; an insulation layer adjacent to the shell fabric layer, the insulation layer comprising a synthetic padding insulation and an elastomeric nonwoven layer adhered to the synthetic padding insulation; and a liner fabric layer adjacent to the insulation layer, wherein the elastomeric nonwoven layer is oriented toward the liner fabric layer.

Example Clause 32: The composite garment of Example Clause 31, wherein the shell fabric layer has a CFM (cubic feet per minute) rating between 10 CFM and 160 CFM in accordance with ASTM D737.

Example Clause 33: The composite garment of Example Clause 31 or Example Clause 32, wherein the shell fabric layer has a CFM (cubic feet per minute) rating between 25 CFM and 126 CFM in accordance with ASTM D737.

Example Clause 34: The composite garment of any one of Example Clauses 31-33, wherein the shell fabric layer has a CFM (cubic feet per minute) rating between 10 CFM and 75 CFM in accordance with ASTM D737.

Example Clause 35: The composite garment of any one of Example Clauses 31-34, wherein the synthetic padding insulation has a weight ranging from 20 to 80 grams per square meter (gsm).

Example Clause 36: The composite garment of any one of Example Clauses 31-35, wherein the insulation layer has stretch between 20% and 40% in both a machine direction and a cross-machine direction in accordance with ASTM D6614 or ASTM D2594.

Example Clause 37: The composite garment of any one of Example Clauses 31-36, wherein the liner fabric layer has an air permeability greater than 75 CFM.

Example Clause 38: The composite garment of any one of Example Clauses 31-37, wherein the liner fabric layer has holes up to 1 millimeter in diameter.

Example Clause 39: The composite garment of any one of Example Clauses 31-38, wherein the liner fabric layer allows for evaporative heat transfer from a body to a microclimate of the composite garment.

Example Clause 40: The composite garment of any one of Example Clauses 31-39, wherein the liner fabric layer has an air permeability from 25 CFM to 126 CFM.

Example Clause 41: The composite garment of any one of Example Clauses 31-40, wherein the liner fabric layer has an air permeability of 200 CFM or greater.

Example Clause 42: The composite garment of any one of Example Clauses 31-41, wherein the insulation layer alone or a package including the shell fabric layer, the insulation layer, and the liner fabric layer has an intrinsic isothermal evaporative resistance Ref from 0.01 to 0.02 [(kPa)(m2)/W], measured in accordance with ASTM F1869 Part B.

Example Clause 43: The composite garment of any one of Example Clauses 31-42, wherein packability of the composite garment is measured by placing the composite garment in a cylindrical fixture and applying a force load to compress the composite garment.

Example Clause 44: The composite garment of any one of Example Clauses 31-43, wherein the force load is applied for a dwell time of about five minutes.

Example Clause 45: The composite garment of any one of Example Clauses 31-44, wherein the packability is determined by repeating the measurement three times and reporting an average compressed final volume.

The foregoing disclosure provides illustration and description but is not intended to be exhaustive or to limit the implementations to the precise form disclosed. Modifications may be made in light of the above disclosure or may be acquired from practice of the implementations. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

Use of the term “about” is intended to describe values either above or below the stated value in a range of approx. +/−10%; in other embodiments the values may range in value either above or below the stated value in a range of approx. +/−5%; in other embodiments the values may range in value either above or below the stated value in a range of approx. +/−2%; in other embodiments the values may range in value either above or below the stated value in a range of approx. +/−1%. The preceding ranges are intended to be made clear by context, and no further limitation is implied. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

1. A composite garment, comprising:
a shell fabric layer;
a liner fabric layer; and
an insulation layer disposed between the shell fabric layer and the liner layer, the insulation layer comprising a synthetic padding insulation having a first side adjacent the shell fabric layer and a second side adjacent the liner fabric layer and an elastomeric nonwoven layer disposed adjacent only one of the first side or the second side of the synthetic padding insulation,
wherein the shell fabric layer has a CFM (cubic feet per minute) rating between 25 CFM and 126 CFM in accordance with ASTM D737,
wherein the synthetic padding insulation has a weight ranging from 20 to 80 grams per square meter (gsm),
wherein the insulation layer has stretch between 20% and 40% in both a machine direction and a cross-machine direction in accordance with ASTM D2594,
wherein the liner fabric layer has an air permeability from 25 CFM to 126 CFM, and wherein the insulation layer alone or a package including the shell fabric layer, the insulation layer, and the liner fabric layer has an intrinsic isothermal evaporative resistance Ref from 0.01 to 0.018 [(kPa)(m2)/W], measured in accordance with ASTM F1869 Part B.

2. A composite material, comprising:
a shell fabric layer;
an insulation layer adjacent to the shell fabric layer, the insulation layer comprising a synthetic padding insulation and an elastomeric nonwoven layer adhered to one side of the synthetic padding insulation adjacent the shell fabric; and
a liner fabric layer adjacent to the insulation layer, wherein the elastomeric nonwoven layer is oriented toward the shell fabric layer,
wherein the composite material has a lower intrinsic isothermal evaporative resistance Ref measured in accordance with ASTM F1869 Part B with the insulation layer, compared to a comparative composite material consisting essentially of the same layers and materials as the composite material, but without the elastomeric nonwoven layer.

3. The composite material of claim 2, wherein the shell fabric layer has a CFM (cubic feet per minute) rating between 10 CFM and 160 CFM in accordance with ASTM D737.

4. The composite material of claim 2, wherein the shell fabric layer has a CFM (cubic feet per minute) rating between 25 CFM and 126 CFM in accordance with ASTM D737.

5. The composite material of claim 2, wherein the shell fabric layer has a CFM (cubic feet per minute) rating between 10 CFM and 75 CFM in accordance with ASTM D737.

6. The composite material of claim 2, wherein the synthetic padding insulation has a weight ranging from 20 to 80 grams per square meter (gsm).

7. The composite material of claim 2, wherein the insulation layer has stretch between 20% and 40% in both a machine direction and a cross-machine direction in accordance with ASTM D6614 or ASTM D2594.

8. The composite material of claim 2, wherein the liner fabric layer has an air permeability greater than 75 CFM.

9. The composite material of claim 8, wherein the liner fabric layer has holes up to 1 millimeter in diameter.

10. The composite material of claim 2, wherein the liner fabric layer has an air permeability from 25 CFM to 126 CFM.

11. The composite material of claim 2, wherein the liner fabric layer has an air permeability of 200 CFM or greater.

12. The composite material of claim 2, wherein the insulation layer alone or a package including the shell fabric layer, the insulation layer, and the liner fabric layer has an intrinsic isothermal evaporative resistance Ref from 0.01 to 0.018 [(kPa)(m2)/W], measured in accordance with ASTM F1869 Part B.

13. The composite material of claim 2, wherein the insulation layer alone or a package including the shell fabric layer, the insulation layer, and the liner fabric layer has an intrinsic isothermal evaporative resistance Ref from 0.01 to 0.017 [(kPa)(m2)/W], measured in accordance with ASTM F1869 Part B.

14. The composite material of claim 2, wherein the insulation layer alone or a package including the shell fabric layer, the insulation layer, and the liner fabric layer has an intrinsic isothermal evaporative resistance Ref from 0.01 to 0.016 [(kPa)(m2)/W], measured in accordance with ASTM F1869 Part B.

15. The composite material of claim 2, wherein the insulation layer alone or a package including the shell fabric layer, the insulation layer, and the liner fabric layer has an intrinsic isothermal evaporative resistance Ref from 0.01 to 0.015 [(kPa)(m2)/W], measured in accordance with ASTM F1869 Part B.

16. The composite material of claim 2, wherein the insulation layer alone or a package including the shell fabric layer, the insulation layer, and the liner fabric layer has an intrinsic isothermal evaporative resistance Ref from 0.01 to 0.014 [(kPa)(m2)/W], measured in accordance with ASTM F1869 Part B.

17. The composite material of claim 2, wherein the insulation layer alone or a package including the shell fabric layer, the insulation layer, and the liner fabric layer has an intrinsic isothermal evaporative resistance Ref from 0.01 to 0.013 [(kPa)(m2)/W], measured in accordance with ASTM F1869 Part B.

18. A method of manufacturing a composite material, comprising:
forming an insulation layer by adhering an elastomeric nonwoven layer to a synthetic padding insulation;
disposing a shell fabric layer adjacent the insulation layer; and
disposing a liner fabric layer adjacent the insulation layer such that the elastomeric nonwoven layer is oriented toward the shell fabric layer.

19. The method of claim 18, wherein one or both of the shell fabric layer or the liner fabric layer has a CFM (cubic feet per minute) rating between 25 CFM and 126 CFM in accordance with ASTM D737.

20. The method of claim 19, wherein the insulation layer alone or a package including the shell fabric layer, the insulation layer, and the liner fabric layer has an intrinsic isothermal evaporative resistance Ref from 0.01 to 0.018 [(kPa)(m2)/W], measured in accordance with ASTM F1869 Part B.
